(19) United States
(12) Patent Application Publication
(10) Pub. No.: US 2020/0356378 A1
(43) Pub. Date: Nov. 12, 2020

(54) SYSTEMS AND METHODS FOR IMPLEMENTING HYPERTEXT TRANSFER PROTOCOL-BASED VIRTUAL MEDIA IN A MANAGEMENT CONTROLLER

(71) Applicant: Dell Products L.P., Round Rock, TX (US)

(72) Inventors: Babu Krishna CHANDRASEKHAR, Round Rock, TX (US); Murali K. SOMAROUTHU, Austin, TX (US)

(73) Assignee: Dell Products L.P., Round Rock, TX (US)

(21) Appl. No.: 16/403,993

(22) Filed: May 6, 2019

(51) Int. Cl. G06F 9/4401; H04L 29/08

(52) U.S. Cl. CPC G06F 9/4416; G06F 9/4406; H04L 67/16; H04L 67/02

(57) ABSTRACT

An information handling system may include a host system comprising a host system processor and a management controller communicatively coupled to the host system and configured to perform out-of-band management of the information handling system. The management controller may be further configured to receive a user-provided network address for a virtual media file and based on the network address, mount the virtual media file in order to emulate the virtual media file as a storage medium accessible to the host system.

### TECHNICAL FIELD

The present disclosure relates in general to information handling systems, and more particularly to methods and systems for implementing Hypertext Transport Protocol-based virtual media in a management controller.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To enable a single and simplified process for performing operating system deployments and updates, a bootable image file may be used. Often, a bootable image file may comprise a disk image of an optical disc comprising an archive file that includes all information that would be written to an optical disc, sector by sector, including the optical disc file system (e.g., an ISO image file). However, it is often desirable to access such bootable image file from storage media other than a physical optical disk, including remote network access.

### SUMMARY

In accordance with the teachings of the present disclosure, the disadvantages and problems associated with accessing a bootable image file may be reduced or eliminated.

In accordance with embodiments of the present disclosure, an information handling system may include a host system comprising a host system processor and a management controller communicatively coupled to the host system and configured to perform out-of-band management of the information handling system. The management controller may be further configured to receive a user-provided network address for a virtual media file and based on the network address, mount the virtual media file in order to emulate the virtual media file as a storage medium accessible to the host system.

In accordance with these and other embodiments of the present disclosure, a method may include receiving, at a management controller of an information handling system communicatively coupled to a host system of the information handling system and configured to perform out-of-band management of the information handling system, a user-provided network address for a virtual media file, and based on the network address, mounting, by the management controller, the virtual media file in order to emulate the virtual media file as a storage medium accessible to the host system.

In accordance with these and other embodiments of the present disclosure, a management controller for performing out-of-band management of an information handling system may include a processor and a program of instructions embodied in non-transitory computer-readable media. The instructions may be configured to, when read and executed by the processor, receive, at a management controller, a user-provided network address for a virtual media file, and based on the network address, mounting, by the management controller, the virtual media file in order to emulate the virtual media file as a storage medium accessible to a host system of the information handling system, wherein the host system is communicatively coupled to the management controller.

In accordance with these and other embodiments of the present disclosure, an article of manufacture may include a non-transitory computer-readable medium and computer-executable instructions carried on the computer-readable medium, the instructions readable by a processor. The instructions, when read and executed, may cause the processor to, in an information handling system comprising a host system comprising a host system processor and a management controller communicatively coupled to the host system and configured to perform out-of-band management of the information handling system, receive, at a management controller, a user-provided network address for a virtual media file, and based on the network address, mount, by the management controller, the virtual media file in order to emulate the virtual media file as a storage medium accessible to the host system of the information handling system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an example user interface screen that may be displayed to a user of the information handling system shown in FIG. 1 to allow the user to mount Hypertext Transfer Protocol-based virtual media, in accordance with embodiments of the present disclosure; and

FIG. 3 illustrates a flow chart of an example method for implementing Hypertext Transfer Protocol-Based virtual media in a management controller, in accordance with embodiments of the present disclosure.

### DETAILED DESCRIPTION

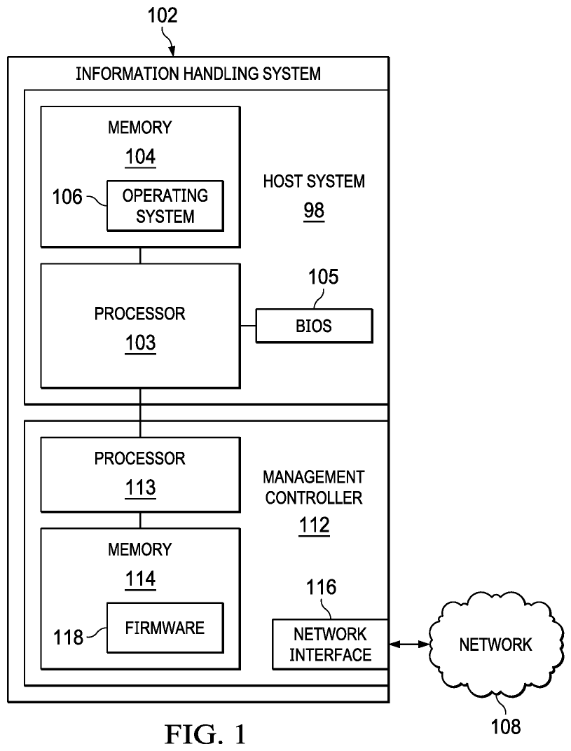

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, and a management controller 112 communicatively coupled to processor 103. In operation, processor 103, memory 104, and BIOS 105 may comprise at least a portion of a host system 98 of information handling system 102. For purposes of clarity and exposition, information handling system 102 has been depicted to comprise only a single host system 98. In some embodiments, information handling system 102 may comprise a plurality of host systems 98.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Management controller 112 may be configured to provide management facilities for management of information handling system 102. Such management may be made by management controller 112 even if information handling system 102 is powered off or powered to a standby state. Management controller 112 may include a processor 113, a memory 114, and a network interface 116 communicatively coupled to processor 113. In certain embodiments, management controller 112 may include or may be an integral part of a baseboard management controller (BMC) or a remote access controller (e.g., a Dell Remote Access Controller or Integrated Dell Remote Access Controller).

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in memory 114 and/or another component of information handling system 102 or management controller 112. As shown in FIG. 1, processor 113 may be communicatively coupled to processor 103. Such coupling may be via a Universal Serial Bus (USB), System Management Bus (SMBus), Peripheral Component Interconnect Express (PCIe) bus, and/or one or more other communications channels.

Memory 114 may be communicatively coupled to processor 113 and may include any system, device, or apparatus configured to retain program instructions and/or data for a period of time (e.g., computer-readable media). Memory 114 may include RAM, EEPROM, a PCMCIA card, flash memory, magnetic storage, opto-magnetic storage, or any suitable selection and/or array of volatile or non-volatile memory that retains data after power to management controller 112 is turned off. As shown in FIG. 1, memory 114 may have stored thereon firmware 118.

Firmware 118 may comprise any program of executable instructions, or aggregation of programs of executable instructions, configured to perform the functionality of management controller 112, including without limitation implementing Hypertext Transfer Protocol-based virtual media in management controller 112. In addition, firmware 118 may include all or a portion of a network stack for network communication via a network interface (e.g., network interface 116 for communication over network 108). Active portions of firmware 118 may be executed by processor 113. In some embodiments, firmware 118 may be implemented with an operating system, such as Linux, for example.

Network interface 116 may include any suitable system, apparatus, or device operable to serve as an interface between its management controller 112 and network 108. Network interface 116 may enable management controller 112 to communicate over network 108 using any suitable transmission protocol and/or standard, including without limitation all transmission protocols and/or standards enumerated below with respect to the discussion of network 108. In some embodiments, network interface 108 may provide an “out-of-band” management channel for remote management of information handling system 102 wherein such out-of-band management channel is physically isolated from an “in-band” channel for which host system 98 may communicate with network 108 or another network.

As shown in FIG. 1, network interface 116 may be communicatively coupled to an external network 108. Network 108 may be a network and/or fabric configured to couple management controller 112 to one or more information handling systems other than information handling system 102. In some embodiments, network 108 may include a communication infrastructure, which provides physical connections, and a management layer, which organizes such physical connections, as well as organizes management controller 112 and information handling systems coupled to network 108. In the same or alternative embodiments, network 108 may allow block I/O services and/or file access services to storage resources communicatively coupled to network 108. Network 108 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet, or any other appropriate architecture or system that facilitates the communication of signals, data, and/or messages (generally referred to as data). Network 108 may transmit data using any storage and/or communication protocol, including without limitation, Fibre Channel, Frame Relay, Asynchronous Transfer Mode (ATM), Internet protocol (IP), other packet-based protocol, small computer system interface (SCSI), advanced technology attachment (ATA), serial ATA (SATA), advanced technology attachment packet interface (ATAPI), serial storage architecture (SSA), integrated drive electronics (IDE), and/or any combination thereof. Network 108 and its various components may be implemented using hardware, firmware, software, or any combination thereof.

Although not expressly depicted in FIG. 1, one or more storage resources may be communicatively coupled to network 108 and accessible by management controller 112 via network 108, including without limitation via Hypertext Transfer Protocol. In some embodiments, such remote storage resources may have stored thereon a bootable image file. A bootable image file may comprise a disk image which is bootable and which includes any suitable content, for deploying content (e.g., an operating system) or updating content on information handling system 102 and/or other information handling systems. In some embodiments, such bootable image file may comprise a disk image of an optical disc comprising an archive file that includes all information that would be written to an optical disc, sector by sector, including the optical disc file system (e.g., an ISO image file). Accordingly, management controller 112 may be configured, as described in more detail below, to access a disk image via Hypertext Transfer Protocol and emulate such image to host system 98 such that the image appears as optical media to host system 98.

In addition to processor 103, memory 104, and management controller 112, information handling system 102 may include one or more other information handling resources.

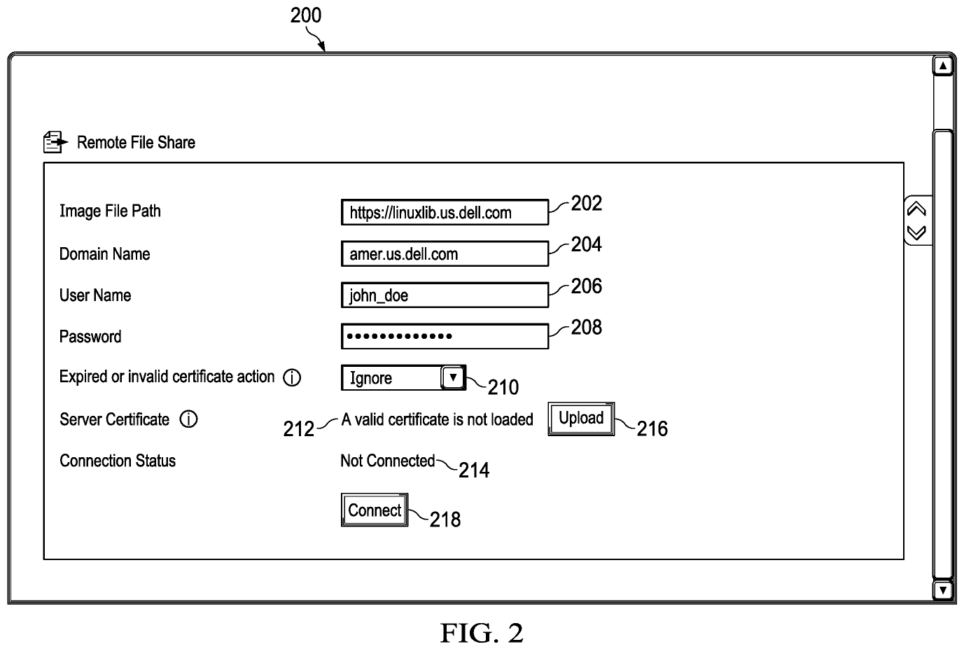

FIG. 2 illustrates an example user interface screen 200 (or portion of a user interface screen) that may be displayed to a user of information handling system 102 shown in FIG. 1 to allow the user to mount Hypertext Transfer Protocol-based virtual media, in accordance with embodiments of the present disclosure. In some embodiments, such user interface screen 200 may be displayed locally to information handling system 102, for example on a display device locally coupled to or integral to information handling system 102. In other embodiments, such user interface screen 200 may be displayed remotely from information handling system 102, for example within a management console communicatively coupled to management controller 112 via a network. In some embodiments, user interface screen may appear within a browser window of a web browser accessing a network address of management controller. In some embodiments, firmware 118 may cause display of user interface screen 200 and may receive user input associated with user interaction with user interface screen 200.

As shown in FIG. 2, user interface screen 200 may include user interface elements 202, 204, 206, 208, 210, 216, and 218 for allowing graphical user interaction with management controller 112. For example, user interface element 202 may include a text field for a user to enter a Uniform Resource Locator (URL) of a network address for a bootable image file. User interface elements 204, 206, and 208 may include text fields for the user to enter credentials for accessing the bootable image file from the network address entered in user interface element 202, wherein such credentials may include, without limitation, a domain name that maintains credentials, a user name, and a password associated with the user name. As another example, user interface element 210 may include a drop-down menu that receives a user preference on how to handle expired or invalid security certificates associated with the network address. User interface element 216 may include a button that may open a further window for inputting a security certificate and user interface element 218 may include a button that indicates the user has entered necessary information for accessing the bootable image file and desires to connect to the bootable image file. Otherwise user interface elements 212 and 214 may provide status information to the user.

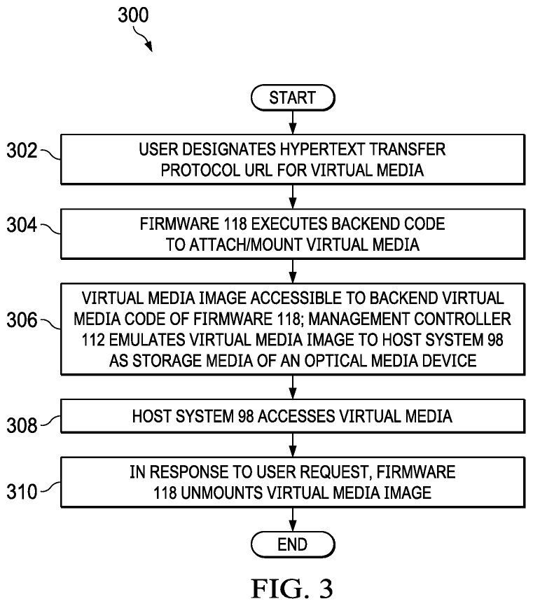

FIG. 3 illustrates a flow chart of an example method 300 for implementing Hypertext Transfer Protocol-Based virtual media in management controller 112, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, a user may designate a Hypertext Transfer Protocol URL for the virtual media (e.g., a bootable image file) to be accessed by management controller 112. Such virtual media may be stored to a web server defined by the URL with an appropriate content type (e.g., a content type of “octet-stream” in connection with the Internet Engineering Task Force Request for Comment (RFC) 2305).

At step 304, firmware 118 may execute backend code to attach the virtual media. For example, as part of virtual media attachment, firmware 118 may read individual bit streams from the remote web-based URL using credentials supplied by the user within user interface screen 200. Such reading of individual bit streams may be performed by raw reading as using GNU's wget function or by performing a mount using any appropriate software for mounting the virtual media defined by the URL.

At step 306, once the remote virtual media image is mounted, such virtual media image may be accessible to backend virtual media code of firmware 118 as if the virtual media image is a local file, such as /tmp/rfs. Thus, at this point, such virtual media image may appear to host system 98 as storage media of an optical media device.

At step 308, host system 98 may use the virtual media image to perform any suitable task, including without limitation operating system deployment and operating system update.

At step 310, in response to a user request (e.g., via user interface screen 200) to disconnect from the virtual media image, firmware 118 may cause the remote virtual media image to be unmounted. After completion of step 310, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented in whole or part using a variety of configurations of information handling system 102 and/or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

1. An information handling system comprising:
a host system comprising a host system processor; and
a management controller communicatively coupled to the host system and configured to perform out-of-band management of the information handling system, the management controller further configured to:
receive a user-provided network address for a virtual media file having an octet-stream content type; and
based on the user-provided network address, mount the virtual media file by reading streams of individual bits from the use-provided network address in order to emulate the virtual media file as a storage medium accessible to the host system.

2. The information handling system of claim 1, wherein the virtual media file is a bootable image file.

3. The information handling system of claim 1, wherein the virtual media file is a disk image of an optical disc.

4. The information handling system of claim 3, wherein the management controller is further configured to emulate the virtual media file as storage media of an optical media device accessible to the host system.

5. The information handling system of claim 1, wherein the network address is a Hypertext Transfer Protocol Uniform Resource Locator.

6. A method comprising:
receiving, at a management controller of an information handling system communicatively coupled to a host system of the information handling system and configured to perform out-of-band management of the information handling system, a user-provided network address for a virtual media file, wherein a content type of the virtual media file is octet-stream; and
based on the user-provided network address, mounting, by the management controller, the virtual media file by reading streams of individual bits from the virtual media file in order to emulate the virtual media file as a storage medium accessible to the host system.

7. The method of claim 6, wherein the virtual media file is a bootable image file.

8. The method of claim 6, wherein the virtual media file is a disk image of an optical disc.

9. The method of claim 8, further comprising emulating, by the management controller, the virtual media file as storage media of an optical media device accessible to the host system.

10. The method of claim 6, wherein the network address is a Hypertext Transfer Protocol Uniform Resource Locator.

11. A management controller for performing out-of-band management of an information handling system comprising:
a processor; and
a program of instructions embodied in non-transitory computer-readable media and configured to, when read and executed by the processor:
receive, at a management controller, a user-provided network address for a virtual media file wherein the virtual media file has an octet stream content type; and
based on the user-provided network address, reading, by the management controller, streams of individuals bits from the virtual media file to retrieve raw data in the virtual media file in order to emulate the virtual media file as a storage medium accessible to a host system of the information handling system, wherein the host system is communicatively coupled to the management controller.

12. The management controller of claim 11, wherein the virtual media file is a bootable image file.

13. The management controller of claim 11, wherein the virtual media file is a disk image of an optical disc.

14. The management controller of claim 13, wherein the instructions are configured to emulate the virtual media file as storage media of an optical media device accessible to the host system.

15. The management controller of claim 11, wherein the network address is a Hypertext Transfer Protocol Uniform Resource Locator.

16. An article of manufacture comprising:
a non-transitory computer-readable medium; and
computer-executable instructions carried on the computer-readable medium, the instructions readable by a processor, the instructions, when read and executed, for causing the processor to, in an information handling system comprising a host system comprising a host system processor and a management controller communicatively coupled to the host system and configured to perform out-of-band management of the information handling system:
receive, at a management controller, a user-provided network address for a virtual media file wherein the virtual media file has an octet stream content type; and
based on the user-provided network address, mount, by the management controller, the virtual media file in order to emulate the virtual media file as a storage medium accessible to the host system of the information handling system, wherein the management controller mounts the virtual media file by reading individual bit streams from the virtual media file.

17. The article of claim 16, wherein the virtual media file is a bootable image file.

18. The article of claim 16, wherein the virtual media file is a disk image of an optical disc.

19. The article of claim 18, the instructions for further causing the management controller to emulate the virtual media file as storage media of an optical media device accessible to the host system.

20. The article of claim 16, wherein the network address is a Hypertext Transfer Protocol Uniform Resource Locator.
